(19) United States
(12) Patent Application Publication
(10) Pub. No.: US 2002/0116506 A1
(43) Pub. Date: Aug. 22, 2002

(54) Cross-MVS system serialized device control

(76) Inventor: Jim Lautner, Alberta (CA)

Correspondence Address: SEAN W. GOODWIN, 237- 8TH AVE. S.E., SUITE 660, THE BURNS BUILDING, CALGARY, AB, T2G 5C3, CA

(21) Appl. No.: 09/785,331

(22) Filed: Feb. 20, 2001

(51) Int. Cl. G06F 15/16; G06F 13/14

(52) U.S. Cl. 709/229; 710/241

(57) ABSTRACT

Method and apparatus for serializing access to devices across multiple OS/390 systems. A subsystem intercepts device allocation requests and manages reserve/release operation of a shared control database. The control database flags allocated device as being in use, regardless of which image on which system or image reserved it. The control database can be queried by any system at anytime, preferably on a regular heartbeat basis, for information on the availability of a resource or health of a system and if a system has become non-responsive, the resource can be released for other images to use.

### FIELD OF THE INVENTION

The present invention relates to a system for sharing input and output devices, such as tape resources, amongst multiple S/390 systems and their OS/390images. The system incorporates allocation, serialization and locking capabilities so as to manage the shared resources and prevent a device from being allocated to more than one system at a time.

### BACKGROUND OF THE INVENTION

In mainframe computer installations, independent operating systems (O/S) are operational as multiple images within a single physical hardware structure or system (a box containing one or more CPU's) or a combination of software and multiple boxes. These O/S utilize one or more individual processing units (processors) and share a number of separate physical input/output (I/O) devices, such as robotic tape library, disk drives or peripherals. Sharing of devices permits each O/S to utilize a common peripheral such as the tape drives within a robotic library.

This sharing enhances efficiency by utilizing a single device, accessed across a number of O/S. Each O/S is connected and accesses a shared device through a hardware defined communication link or path. In older mainframes, such as IBM System 370 series computers, there is provided upwards of eight paths for as IBM System 370 series computers, there is provided upwards of eight paths for each system. The path took the form of dedicated and multiple physical connections between the box and corresponding ports on the shared device or through multiple addresses on a bus between the control unit and the device. On the system side of the control unit, the path is typically formed of appropriate software messages, e.g. channel control words, carried over a hardware linkage from the system to the control unit. The entire connection from the CPU to the shared device is commonly referred to as a “channel”. Each channel is uniquely associated with one shared device, has a unique channel path identifier and has logically separate and distinct facilities for communicating with its attached shared device and the CPU to which that channel is attached. A channel may contain multiple sub-channels, each of which can be used to communicate with a shared device. In this instance, sub-channels are not shared among channels; each sub-channel is associated with only one path. For further details in this regard, the reader is referred to, e.g., page 13-1 of Principles of Operation—IBM System/370 Extended Architecture, IBM Publication Number SA22-7085-1, Second Edition, January 1987 (International Business Machines Corporation), which is hereinafter referred to as the “System/370 ESA POP” manual. Hence, commands that emanate from each of these systems, e.g. CPUs travel by way of their associated addressed channels to the shared device for execution thereat with responses, if any, to any such system from the device traveling in an opposite direction. The CPU can also logically connect or disconnect a shared device from a path by issuing an appropriate command, over the path, to the control unit associated with that device.

While these physical devices are shared among several different images, each of these devices is nevertheless constrained to execute only one command at a time. Accordingly, several years ago, the art developed a so-called “Reserve/Release” technique to serialize a device across commands issued by a number of different images.

One prevalent operating system by IBM is known as the Multiple Virtual Storage image or MVS image. This O/S is also known as MVS/ESA and most currently is OS/390.

One successful mechanism for sharing data between multiple systems has been to utilize a coupling facility (CF). A CF is a hardware and software solution for hardwired coupling of multiple systems. The CF links multiple MVS systems, permitting multisystem data sharing and balancing of workloads between and across hardwire-linked systems. Physically, the CF is situated between discrete boxes. CFs are expensive, and are associated with significant overhead to manage what is termed a parallel sysplex.

Note that multiple MVS images may exist in a single box or MVS system. Multiple MVS systems are termed a complex.

Note that it is often desirable to maintain developer and test MVS systems separate from the production MVS systems, one reason being to avoid potential corruption of the essential production systems during O/S upgrades and application testing. However, even if separate, it would be convenient to be able to access and share tape devices.

The problem with sharing across MVS systems stems from having to coordinate the device allocation between images. Without some form of manual or automated management, data integrity is at risk if more than one image tries to access or allocate a tape device at the same time.

An operator can manually enter commands to temporarily dedicate a drive to one image prior to allocation but this intervention is labor intensive and prone to errors. The larger the number of images that share these devices, the more difficult it becomes for an operator to manage.

Many sites choose to permanently dedicate tape drives to each image. This decision is expensive and can be an inefficient use of tape resources.

A single MVS system having multiple jobs, can access devices serially and a manager controls allocation through a common database. Unfortunately, while allocation conflicts for a shared device can be managed successfully on one system, the manager is unaware and unable to manage allocation requests from other images and other systems.

### SUMMARY OF THE INVENTION

The cross-system tape control (“XTC”) of the present invention allows input and output devices that are connected to multiple MVS images, such as tape resources, to be online simultaneously to all systems with physical connectivity to the common resource. Additional features of XTC system include the ability to limit the number of tape drive resources that a particular image can obtain, but not restrict those resources to specific physical devices. A command interface with the operator can display the status of the entire shared tape drive environment from any single system in a XTC complex.

XTC provides an opportunity to make better use of a typically underutilized resource. By making tape drives available to multiple systems simultaneously, it is conceivable that sites should be able to reduce the number of resources required when compared with environments that have different physical resources attached to each system.

Under prior art systems, normally a MVS image within a MVS system can allocate and deallocate without hazard, implicitly knowing that it is the owner of the devices and if it didn't allocate a device then it should be available for it later.

This approach is fine until another MVS system's image tries to make an allocation. Conventionally, not knowing of the existence of other images, the image writing the control database would be able only to update its own allocation information and be insensitive to the allocations of others.

The solution is to provide a form of cross-device control or cross-tape control (“XTC”) with its ability to allow tape resources that are connected to multiple MVS images to be online simultaneously to all systems. XTC manages the shared resources and prevents the device from being allocated by more than one system at a time.

XTC allows the sharing of tape drives, whether round or square, or robotic libraries between multiple parallel SYSPLEXES, multiple logical partitions or LPARS, or multiple LPARS and SYSPLEXES running any mix of MVS/ESA 5.2 and OS/390 operating systems. XTC operates independently of global resource serialization of resources across multiple MVS images.

The key is for each system in an XTC complex to monitor each and every other system. If any XTC member becomes busy, blocked otherwise inoperative, the resources owned by the inoperative system can be released by any other operating XTC environment.

Some typical scenarios in which XTC could be deployed include utilization of older technology tape drives (such as IBM compatible 3420s) that are used infrequently, but are still required on a number of different systems. Rather than needing to provide physically separate and isolated devices on multiple systems, a smaller number of resources can be shared and used as required. Further, a production environment and a test environment can usefully share a tape resource where the primary user of the tape resource is the production environment. The resources can be shared between the environments without having to vary devices offline and online as required. In current systems, such as a multiple SYSPLEX environment, XTC enables sharing tape drives among systems in different SYSPLEXES and the usual process of IEFAUTOS does not permit device sharing across a SYSPLEX boundary.

Simplistically, the above is accomplished by providing a supervisor (XTC) which manages reservation of a device on a system, by an image, and flags it as being in use, regardless of which image on which system reserved it. A common shared control database is required for storing the resource utilization and the reserving image identity. The supervisor intercepts device allocation requests and takes over the reserve/release operation. The control database can be queried by any system at anytime, preferably on a regular heartbeat basis, for information on the availability of a resource or health of a system. The supervisor can perform regular checks on the use of resources, and if a resource is in use by a system that has become non-responsive, the supervisor can release the resource for other images to use.

In a broad aspect of the invention a method is provided for cross-system resource sharing of a limited number of serially accessible devices, such as tape drives or printers, which are physically connected in a complex of MVS images, comprising the steps of:

providing a control database shared by all MVS images in the complex;

periodically monitoring the control database for devices which have been allocated and by which image;

intercepting a device allocation request from a MVS image;

performing a request/release operation on the control database to determine if a device or devices satisfy the request;

granting allocation of the available devices in the control database to the requesting MVS image if the request is satisfied;

updating the control database for flagging an allocated device or devices as being unavailable, regardless of which image made the allocation; and

releasing the control database.

The above method can be incorporated in a system, preferably operating under OS/390, comprising:

a shared control database, preferably a DASD or on a TCP/IP network;

means for request/release updating operations on the control database for flagging which device or devices are unavailable as having been allocated by an MVS system and which MVS system allocated the device or devices;

means for intercepting a device allocation request, preferably being a hook such as a subsystem interface function call 78, and which MVS system made the request, using the request/release means for determining if the request can be satisfied from the available device or devices and, if so, satisfying the requests and flagging the allocated devices as unavailable to any MVS system and updating the control database accordingly.

### BRIEF DESCRIPTION OF THE DRAWINGS

FIG. 1 is a flow diagram illustrating the prior art arrangement of systems accessing multiple tape devices;

FIG. 2 is a flow diagram illustrating an arrangement of systems accessing multiple tape devices utilizing an embodiment of the present invention which uses a shared control database;

FIG. 3 is a flow diagram illustrating an arrangement of systems accessing multiple tape devices utilizing an embodiment of the present invention which uses a TCP/IP network interface;

FIG. 4 is a flow chart of one implementation of XTC intercepting an allocation where a device is available;

FIG. 5 is a flow chart of one implementation of XTC intercepting an allocation where insufficient devices are available; and

FIG. 6 illustrates code and the results of various status requests made by a user.

### DETAILED DESCRIPTION OF THE PREFERRED EMBODIMENT

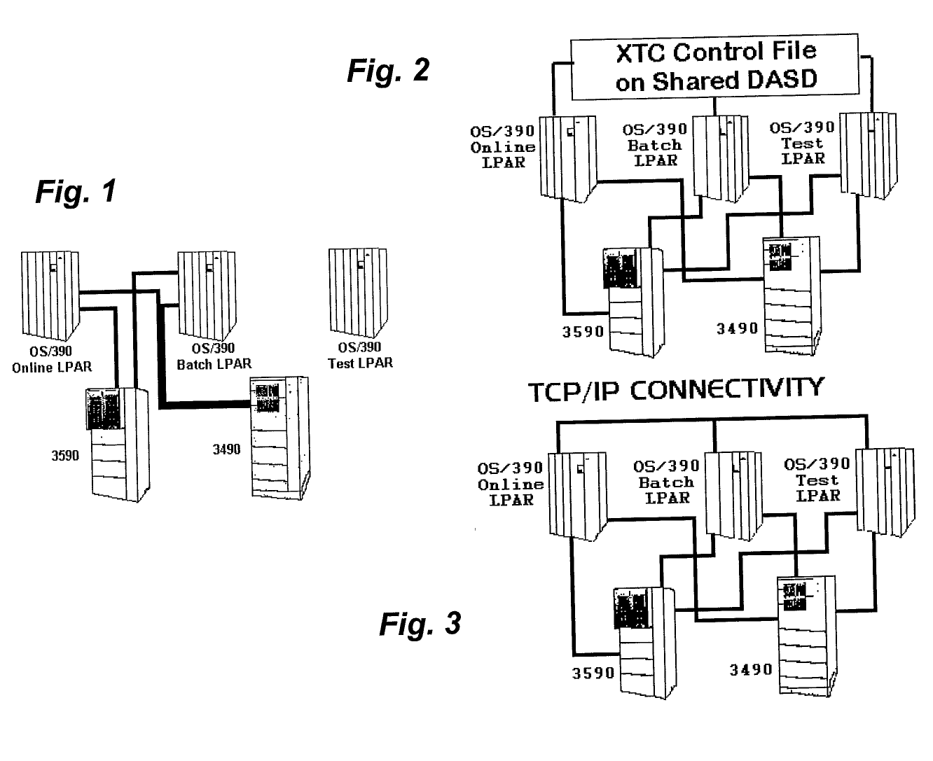

Having reference to FIG. 1, a prior art system of connected MVS systems is illustrated, specifically one MVS online system under OS/390 and which is physically connected to devices provided by two IBM or compatible tape drives; a 3590 and a 3490. A batch MVS system, also under OS/390 is connected to the drives. A test MVS system is maintained separately and has no access to the drives.

Having reference to FIGS. 2 and 3, a cross-system tape control or XTC is implemented for sharing the resources provided by the two tape drives or robotic libraries. A complex of three MVS systems is illustrated.

In order to share allocation information among all systems that are participating in a given complex, there is a requirement for a control file or database of information accessible or sharable between every system wishing to participate in a particular XTC complex. This shared resource could include a file stored on a Direct Access Storage Device (“DASD”) unit (FIG. 2) or be one that communicates across a TCP/IP network interface (FIG. 3). The physical devices, resources or tape drives that will be shared must also be physically connected to all systems in a complex.

While the application of the preferred embodiment is typically applied to allocation of tape resources, the invention is equally applicable to any shared device or serially accessed resource such as printers.

In the case of a common control database, under shared DASD. XTC must ensure serialized access to the database information. This is managed through a combination of hardware and software file locking. This is also known as request/release or ENQ/DEQ protocol. Such request/release protocol protects common devices in certain phases of multitasking execution or operation.

In conventional systems, if a resource is available and an allocation request for a device is received from an image, a System Resource Management (SRM) algorithm, operating under that image, determines which of the one or more devices to allocate to that request. In the case of tape resources, SRM causes a tape to be mounted for use.

The hardware lock is used for only a very short period of time at XTC startup to do a validation on whether or not the control database has been initialized. Once that validation has occurred, XTC uses a software lock on the control database under request/release protocols. This technique allows other systems in the XTC complex to read the control database even if they can't currently obtain the database lock. This permits better reporting on which MVS system currently owns the lock in the event that problems arise on the system currently owning the software lock. If an MVS system freezes, its resources can be released from the control database from any active system in the XTC complex and made available to the other systems.

Where the common database is available on a TCP/IP network interface, similar issues exist but the data exchange method differs. In this case, the database status information is maintained internally on all systems. A master system maintains ultimate veto authority for any requests. There can be one and only one master system in any given XTC complex. Through network commands, a problem system can be released from the complex from the master system.

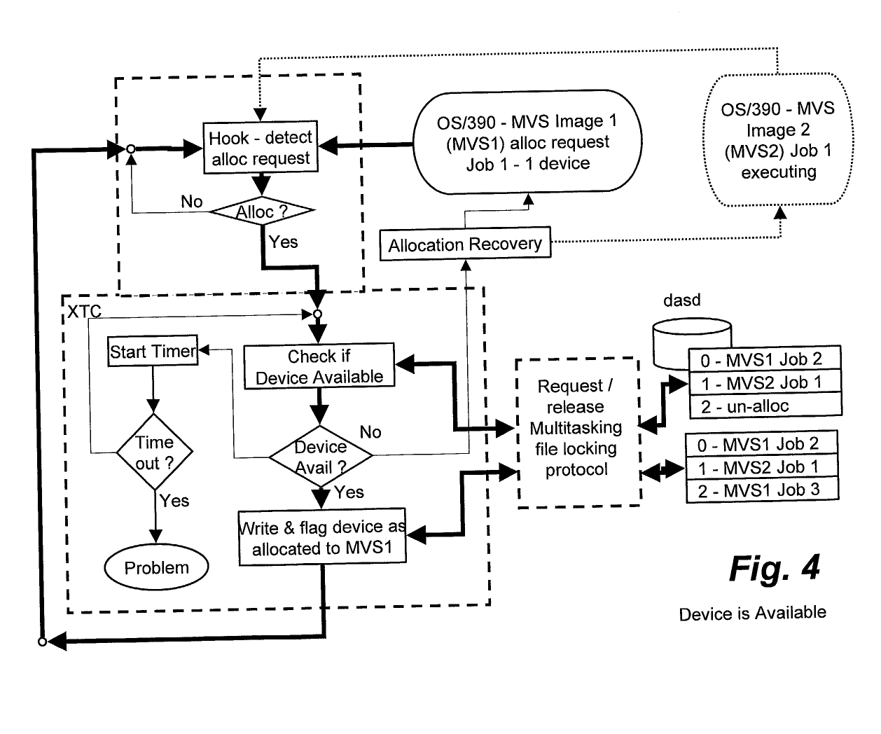

Having reference to FIG. 4, XTC is a subsystem (dotted boundary) operational under each operating system and is triggered whenever an allocation request is intercepted. XTC maintains the control database and allocates devices as various MVS images allocate them. As one MVS system is unaware of another, XTC performs an allocation of the devices which, being in use and unavailable, may not have been allocated by or to the currently requesting system. Accordingly, one image cannot allocate a device which has been already allocated by itself or another system.

XTC utilizes means such as an interface point or special hook for intercepting allocation requests. Basically, the XTC process intercepts every tape allocation request on the MVS image making the request. When an MVS image makes an allocation request, XTC examines the current shared device status to determine if a device of the requested type is available. If the request can be satisfied (i.e. a device or devices of the correct number and type are available), the request is satisfied and MVS allocation is allowed to proceed. XTC updates its control database with flags indicating devices that are being allocated, grants that request and allocates the device or devices. In the control database, XTC writes or flags allocated devices as being unavailable and which MVS system owns them.

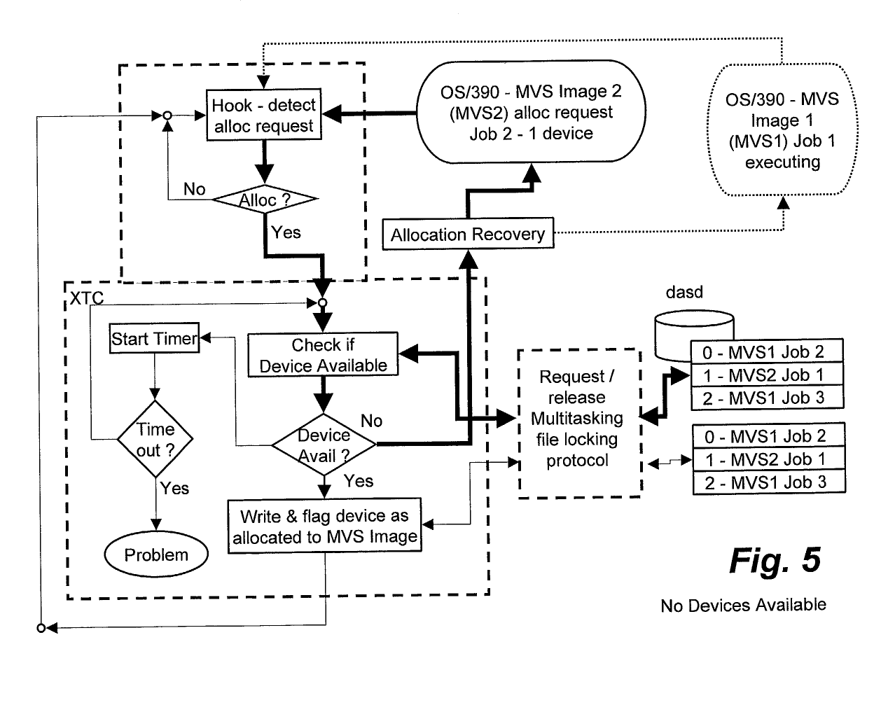

Having reference to FIG. 5, if an MVS image makes an allocation request for a job requiring one or more devices and insufficient devices are available, or the wrong type of devices are available, then that image's job becomes queued. At some point, when an image deallocates a device, XTC flags the device as available. At the next heartbeat or request/release cycle, those MVS images having jobs in their queues recognize that a device is available and their O/Ss re-drive allocation recovery—the MVS image again makes its allocation request.

A global storage table of device allocations, and their owners, is maintained in the control database. Each MVS system is able to access the global table and ascertain the allocation status of devices allocated by other systems.

On a regular, periodic cycle, such as on a 2 second timer pop, each MVS image interrogates the control database in the complex. Accordingly, when a device is de-allocated, the control database contents change, a device or devices are flagged as available and the requesting MVS image enters automatic allocation recovery so that the next job pending in the queue can proceed through allocation.

To minimize processing overhead, a local storage table of system allocations can be maintained on each MVS system. XTC then enables each MVS image to maintain and perform virtual, background or logical allocations of the other image's allocations as a mirror of the control database status. Therefore an MVS system will be aware that a device is unavailable, even though another system may have claimed it.

The means by which XTC is aware that a MVS image is making an allocation request is, in one embodiment, through a hook into the O/S. In most cases, this hook is provided by the subsystem interface (SSI) provided under OS/390. SSI function code (FC) 78 enables one to intercept allocation requests and override the SRM specification. Further, SSI FC 78 permits flagging of the other devices as not being available either.

At the simplest level, if an MVS image makes an allocation request, the DASD database file or control database is queried under a typical request/release format. A software lock is applied on the control file, if possible. If the control file is already locked, then this image waits until it can gain control. Predetermined wait thresholds can be set so that a wait duration greater than the threshold would indicate a problem.

When the control database becomes free, the control file's-device allocated status is cross referenced again with the SSI FC 78 information to determine if a device is available to satisfy the current request. If resource availability is confirmed, then the image claims the resource, writes the new status to the control file and unlocks or releases the software lock.

If an MVS image makes an allocation request for n+1 resources and only n are available, then the operating system for the image commences an allocation recovery process occurs. If the device is not off-line, and dependent upon a specified allocation algorithm, then the image might wait and hold the device until another/others become free; or the image might wait and not hold the device so that another task, having lesser device demands might use the device in the interim.

In the latter no-hold situation, that image will not get any of its requested allocation—simply, the system will not hold up resources for that image if others could use n or less resources. To make the resources available to other less demanding images, an automated unallocation takes place.

While the method can be implemented in any shared resource situation, the preferred implementation of XTC is with systems operating under MVS/ESA 5.2 or any release of OS/390 due to those systems having provided convenient subsystem interfaces which enable interception of the allocation requests. Software implementing the system has been tested running in Job Entry Subsystems 2 (JES2) environments.

XTC is essentially an extension of the OS/390 operating system. As such, it requires the ability for the console operator to query the subsystem about its current status as well as make requests to update the current environment. XTC builds a console interface component that allows the operator to display the status of the XTC subsystem from a number of different perspectives. For modifiable parameters, XTC will accept requests from the operator for updates to these parameters. The console interface is also very important for recovering a failed XTC environment on another system in the XTC complex. XTC must be able to free resources currently held by another system in the complex if that system has experienced a failure.

The operator communication environment in XTC is created by combining components. First of all, MVS must know of the requirement to route, modify and stop requests to the XTC subsystem address space. As well, as part of the subsystem initialization XTC indicates a desire to be able to examine console message traffic and console commands (some of which will be XTC specific).

XTC contains a number of features that allow for continuous operation including monitoring of an event notification listener. ENF (Event Notification Facility) is used to recognize when a dynamic change or successful update has been made to the I/O configuration. If new tape devices have been added, the operator can be prompted to include the devices dynamically under XTC control. As well, if devices that are under XTC control have been deleted from the I/O configuration, a decision to reinitialize XTC can also be made. The event notification listener is used to capture successful updates to an OS/390 I/O environment. When XTC recognizes that a successful update has been made to an I/O configuration a special process is triggered. This process examines the contents of the I/O configuration change. If new tape resources have been added to the I/O configuration, XTC will enter an operator dialogue to determine if the resources should be added to XTC control dynamically.

If resources have been deleted that are currently under the control of XTC, a console message is issued indicating that a restart of XTC will eventually be required to clean up that condition.

When XTC on a given system has gained control of the cross-system resource (either the shared database file lock or the network lock), XTC activity can occur. Five different classes of events could trigger the need to gain control of the environment:

1. XTC operator command has been entered;

2. a subsystem event has occurred;

3. an event notification facility event has occurred;

4. an IBM robotic tape library allocation request has occurred; or

5. a heartbeat status event has occurred.

Although all the events are important for various reasons, the basic event under XTC management is the device or tape allocation event. This can happen as a result of a type 2 class of event (SSI FC 78 has been invoked) or as a result of a type 4 class event (special exit hook invoked for an IBM robotic tape library allocation under its own Storage Management System (SMS).

XTC serializes, through the use of ENQ/DEQ logic, these allocation events. This means that only one allocation event will be actively processed at any point in time. If concurrent events are in process, one event will be active and all others will be queued behind the current active request. This prevents the need to manage the environment in multi-tasking mode and simplifies the code.

On startup, XTC is configured for the number and which devices are to be placed under XTC control. XTC then provides the unique capability of being able to logically limit the number of devices that can be concurrently allocated to a given operating system image. These limits are dynamically changeable through the operator interface. This is also a powerful tool in managing resource usage especially in environments where devices may be shared between a very critical production environment and a less critical development or test environment. Also, XTC is able to react dynamically to the addition of new MVS images and devices, without re-initializing, should it change.

If an allocation request is re-queued as a result of the unit limit feature, special provisions must be made within XTC to handle what is known as allocation recovery conditions. The operating system of an MVS image will re-drive the allocation request a number of times and XTC must keep track of the status to properly report conditions to the operator.

In some cases because of channel path limitations, devices cannot be made online available simultaneously to all OS/390 images that would like access to those devices. For these cases, another class of resource can be placed under XTC control. The resource in this case is the channel itself under Dynamic Channel Reconfiguration (DCR).

XTC monitors console message traffic to determine when an event has occurred that may require DCR. XTC then cross-references its table of DCR resources to determine if the current event falls under XTC influence. If this is an XTC eligible event a number of decisions have to be made on both the local system and other systems that could own this same resource. These decisions include:

the local system must decide if it currently owns the channel path, but it is simply offline;

if not, a request is placed on the cross-system request status;

the system owning the requested resource decided if the devices on the required channel have more than one channel path assigned to them;

if so, is at least one other path online and available;

if not, a check needs to be made if any of the devices are currently allocated;

if so, we must wait for all allocations to end; and

if not, the channel is eligible to be released.

Based on system importance values, provided at system initialization or through the operator interface, XTC then makes a decision to release the channel from the current system. If the channel is released, this information is communicated back to the requesting system through the shared database (either on DASD or through the TCP/IP network).

Specifically, running as a subsystem under OS/390 compatible computer systems or complexes, XTC requires less than 4K of common storage below the 16 MB line and roughly 200K of common storage above the 16 MB line. XTC makes no modification to existing MVS modules.

The standard interface points are the subsystem interface (SSI) and the event notification facility (ENF). XTC can run under either the master or JES subsystem and XTC is configured at startup through a parameter dataset that is included in the XTC procedure. The load modules for XTC must reside in an APF authorized library. The inclusion of the XTC procedure, the XTC load modules, and APF authorization can all be done without a system Initial Program Load (IPL) and XTC will dynamically insert the subsystem control blocks it requires if the XTC subsystem name has not been pre-defined in IEFSSN. These capabilities mean that XTC can be installed with no requirement for an IPL.

As mentioned earlier, XTC makes no modification to existing MVS modules and the standard interface points are SSI and the event notification facility (ENF). Tape allocation is modified by the SSI FC 78 documented interface, which allows for tape device allocation influence.

Several vendors provide robotic tape libraries that can be used by OS/390 operating systems. Devices and libraries, which comply with the generic interface rules, may be controlled through SSI FC 78. However, a robotic library provided by IBM uses Storage Management Subsystem (SMS) to manage the tape devices internal to its library. Tape allocation requests for devices that are SMS managed do not use SSI FC 78 and as a result, device allocation can not be influenced at the same hook point. In other words, this new module does not currently use the subsystem interface as a communication mechanism. Accordingly, a specialized routine, or hook, detects type 4 class events, is applied to capture and influence allocation requests for IBM library devices.

Users can also monitor activity and event conditions internal to XTC. The auditing of allocation events occurs if a specific JCL DD exists in the startup procedure for XTC. This log produces a line item entry for each local and cross-system tape allocation event that occurs.

The user also chooses to allocate a System Management Facilities (SMF) record number for use by XTC. If an SMF record number is included in the startup parameters for XTC, XTC will capture additional internal event conditions in SMF records. This can be useful information for the customer in tracking usage statistics or for the system administrator if a problem situation occurs. The information can be used for debugging purposes.

Installation and Operational Control

Following is sample startup Job Control Language (JCL) for XTC:

//XTC PROC

//XTC EXEC PGM=XTCDRVR,TIME=1440,DPRTY=(15,5)

//STEPLIB DD DSN=XTC.LINKLIB,DISP=SHR

//SHRFILE DD DSN=XTC.SHRFILE,DISP=SHR

//PARMLIB DD DSN=SYS1.PARMLIB(XTCPARMS),DISP=SHR

//XTCLIB DD DSN=XTC.LINKLIB,DISP=SHR

//AUDITLOG DD DSN=XTC.AUDITLOG,DISP=SHR

The STEPLIB is optional if the XTCDRVR program resides in the system linklist.

The SHRFILE represents the XTC control database. It is required. This dataset is a direct access BDAM dataset. The dataset should be set up with DSORG=DA, LRECL=4096, BLKSIZE=4096, KEYLEN=1. A dataset of one or two tracks should be more than adequate for use by XTC.

The PARMLIB contains the startup parameters for XTC. A sample set of XTC parameters may look as follows:

CMDPREFIX=>

SUBSYSNAME=XTC2

UNITLIMIT=32

*TAPEUNIT=ALLTAPE

TAPEUNIT=0380

TAPEUNIT=0381-382

TAPEUNIT=(383,GBL83)

TAPEUNIT=3A0-03A3

3420LIMIT=2

AUTHCODE=XXXXXXXXXXXXXXXX

As can be seen, the XTC subsystem command prefix and subsystem name can be entered through the parameter dataset. There is no default for the command prefix and if no subsystem is provided, XTC will default to a subsystem name of XTC. Limits can be specified for the number of tape drives that can be used by this copy of XTC by using the UNITLIMIT and nnnnLIMIT parameters (for example, where nnnn is either 3420, 3480, 3490, or 3590). You can also specify the devices that XTC is to control. This can be coded in a number of different fashions; using the specific device number, using a range of device numbers, using a device number and a corresponding XTC global name, or indicating that all tape devices are to be controlled by XTC.

The XTCLIB DD is required. Even if all XTC load modules are placed in the system linklist, this DD statement must still be coded to reference the library containing the XTC modules. This is the library that XTC uses for all its directed load module loads.

The AUDITLOG DD is optional. If XTC is running under the Master (MSTR) subsystem, this DD must use a dataset for output. If you are running under your primary JES, you can use a JES SYSOUT dataset for this DD.

Operational Commands

While XTC is up and running, several commands can be used to obtain information about the current XTC status as well as providing the opportunity to change the current XTC environment.

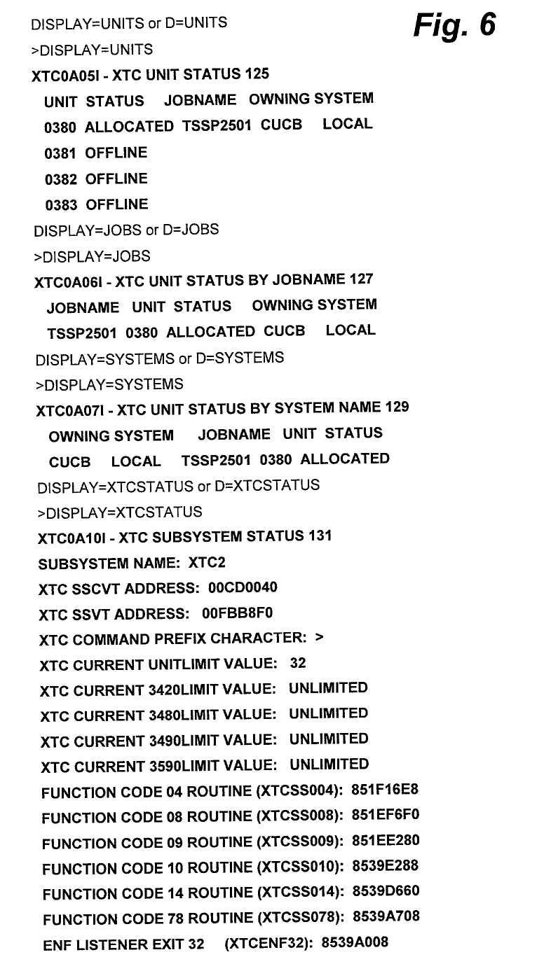

As shown in FIG. 6, system status display commands include the allocation status or on/off line status for a unit, and further, if allocated, who owns it and its job name.

Modify commands include:

F xtcjname,UNITLIMIT=nn

F xtcjname,3420LIMIT=nn

F xtcjname,3480LIMIT=nn

F xtcjname,3490LIMIT=nn

F xtcjname,3590LIMIT=nn

F xtcjname,ADDTAPEUNITS=

F xtcjname,AUTHCODE=

The modify interface also supports the above mentioned display commands. For example:

F xtcjname,DISPLAY=UNITS will yield the same result as the stand-alone DISPLAY=UNITS console command.

Modifying the unit limits is relatively self evident. Valid values for ‘nn’ are 0-32.

One can also add tape units to XTC through the operator interface. For example, if not all of the tape units were initially included under XTC control in the original start up parameters, use the operator command to add them dynamically.

F XTC,ADDTAPEUNITS=0383

If your XTC authorization code needs to be replaced, that can be accomplished through the operator interface as well.

XTC will also automatically recognize dynamic changes to your I/O configuration that impact tape units. If you dynamically change the I/O configuration to add new tape units, XTC will prompt the operator to find out if the device numbers should be added to XTC control. Conversely, if tape UCB's that are under XTC control have been removed from the I/O configuration, XTC will indicate that an XTC restart should be considered.

The embodiments of the invention for which an exclusive property or privilege is claimed are defined as follows:

1. A method for cross-resource sharing of a limited number of serially accessible devices which are physically connected in a complex of MVS images, comprising the steps of:
a) providing a control database shared by all MVS images in the complex;
b) periodically monitoring the control database for devices which have been allocated and by which image;
c) intercepting a device allocation request from a MVS image;
d) performing a request/release operation on the control database to determine if a device or devices satisfy the request;
e) granting allocation of the available devices in the control database to the requesting MVS image if the request is satisfied;
f) updating the control database for flagging an allocated device or devices as being unavailable, regardless of which image made the allocation; and
g) releasing the control database.

2. The method of claim 1 wherein each MVS image periodically performs a request/release on the control database so that
a) if the requesting MVS image has an unsatisfied allocation request in a queue; and
b) if a device or devices are available, then the image enters allocation recovery for re-driving the queued allocation request.

3. The method of claim 1 wherein the control database is stored on a shared dasd.

4. The method of claim 1 wherein the control database is accessed through a TCP/IP network interface.

5. The method of claim 4 wherein a local control database is associated with, and maintained for access by, each MVS image through the TCP/IP network interface, one of which is maintained as a master with veto over the other control databases.

6. The method of claim 1 further comprising:
a) providing a software extension for detecting device allocation requests; and
b) accessing the software extension for intercepting device allocation requests.

7. The method of claim 1 Wherein the operating system is version MVS/ESA 5.2 or a higher operating system further comprising intercepting device allocation requests at a subsystem interface hook.

8. The method of claim 7 wherein the hook is subsystem interface function call 78.

9. The method of claim 1 wherein the operating system is OS/390.

10. The method of claim 1 wherein the shared control database is located on a low activity dasd for minimizing delays in request/release operations.

11. The method of claim 1 further comprising monitoring of the event notification of a change in devices and adjusting the logical allocations in the control database accordingly.

12. A system for cross-resource sharing of a serially accessible device or devices which are physically connected in a complex of MVS systems comprising:
a) a shared control database;
b) means for request/release updating operations on the control database for flagging which device or devices are unavailable as having been allocated by an MVS system and which MVS system allocated the device or devices; and
c) means for intercepting a device allocation request and which MVS system made the request and using the request/release means for determining if the request can be satisfied from the available device or devices and if so, satisfying the requests and flagging the allocated devices as unavailable to any MVS system and updating the control database accordingly.

13. The system of claim 12 wherein
a) the MVS systems are operating under MVS/ESA 5.2 or a higher operating system which has subsystem interface; and
b) the means for intercepting a device allocation request is through the subsystem interface.

14. The system of claim 13 wherein the subsystem interface is function call 78.

15. The system of claim 12 wherein the shared control database is located on a DASD.

16. The system of claim 12 wherein the shared control database access is through a TCP/IP network.

17. The system of claim 12 wherein the control database further comprises means for flagging a device or devices as available or unavailable due to an unallocation or allocation and which MVS system allocated the device or devices.

18. The system of claim 13 wherein the means for request/release updating operations comprises subsystem software.
